(19) United States
(12) Patent Application Publication
(10) Pub. No.: US 2008/0076453 A1
(43) Pub. Date: Mar. 27, 2008

(54) SMS message delivery to non-SMS devices

(76) Inventors: Yigang Cai, Naperville, IL (US); Alok Sharma, Lisle, IL (US)

Correspondence Address: DOCKET ADMINISTRATOR;LUCENT TECHNOLOGIES INC., ROOM 2F-192, 600-700 MOUNTAIN AVENUE, MURRAY HILL, NJ, 07974-0636, US

(21) Appl. No.: 11/526,408

(22) Filed: Sep. 25, 2006

(51) Int. Cl. H04Q 7/20

(52) U.S. Cl. 455/466

(57) ABSTRACT

SMS messages are delivered to non-SMS devices (e.g., wireline devices in legacy communication networks). Upon receiving an incoming SMS message, a message application server (e.g., SMSC) can detect, based on the directory number of the destination terminal, whether the destination terminal is a non-SMS device. If the destination terminal is a non-SMS device, the SMSC initiates delivery of the SMS message according to a delivery profile appropriate to the destination device. Exemplary delivery profiles include a spoken text message format, an ISUP-compatible text format or a caller ID message format.

### FIELD OF THE INVENTION

This invention relates generally to communication networks supporting short message service (SMS) and, more particularly, to apparatus and methods for delivering SMS messages to non-SMS devices (e.g., wireline devices in legacy communication networks).

### BACKGROUND OF THE INVENTION

Short Message Service (SMS) is a service that permits the sending of short messages (also known as text messages) between and among user terminals (e.g., mobile phones) and/or network devices. SMS is a common service in wireless networks including, without limitation, GSM, CDMA and UMTS networks and next-generation IP networks, such as IP Multimedia Subsystem (IMS) networks.

When a user sends an SMS message, it is received and processed by a message application server known as a Short Message Service Center (SMSC) in the originating network. The SMSC extracts information including, without limitation, source and destination addresses (for example, directory numbers or IP addresses) to process and route the message to a destination device in a terminating network. The terminating network can be the same network as the originating network or a different network. Most typically, the terminating network is an SMS network and the destination device is an SMS-capable device (i.e., having the capability to send/receive and display SMS text messages). Depending on the network topology, SMS messages may be communicated using protocols including SMPP (short message peer-to-peer, used in IP networks), GSM MAP (in GSM networks) or ANSI MAP (in CDMA networks).

A problem that arises is that certain “legacy” networks (e.g., traditional wireline networks) do not support, or at least do not fully support SMS service because they usually include one or more devices (“non-SMS devices”) that do not recognize MAP protocols or do not support SMPP. For example, traditional wireline networks can not recognize MAP protocols; and voicemail servers within traditional wireline networks (or even wireline IP networks) typically do not support SMPP. A related problem is that wireline phones used in legacy networks are often non-SMS devices because they are not equipped to receive SMS messages. For example, they may not have text display capability or they may have a text display adapted for services/features other than SMS. Nevertheless, there is a need to provide SMS service to legacy networks and accordingly, there is a need to communicate SMS messages, in some form, to and from non-SMS devices.

### SUMMARY OF THE INVENTION

This problem is addressed and a technical advance is achieved in the art by a feature for extending SMS service to non-SMS devices (e.g., wireline devices in legacy communication networks).

In one embodiment, there is provided a method for delivering an SMS message to a non-SMS device. The method may be implemented by an SMS message application server (e.g., SMSC) in an originating or terminating network. Upon receiving an SMS message directed to a destination terminal, the SMSC determines whether the destination terminal is a non-SMS device. If the destination terminal is a non-SMS device, the SMSC determines a delivery profile appropriate to the non-SMS device and delivers the SMS message content to the non-SMS device according to the delivery profile. The delivery profiles may include, without limitation, a spoken text message format, an ISUP-compatible text format or a caller ID message format for delivering SMS message content.

In another embodiment, there is provided a method of delivering SMS message content via spoken text format. Upon receiving an SMS message directed to a destination terminal, the SMS message content is converted to spoken text, yielding a spoken-text SMS message. A call is attempted to the destination terminal and if the destination terminal answers the call, the spoken-text SMS message is delivered to the destination terminal. If the destination terminal does not answer the call, the spoken-text SMS message may be delivered to a voicemail server for later retreival by the destination terminal.

In still another embodiment, there is provided a method of delivering SMS message content via ISUP message format. Upon receiving an SMS message directed to a destination terminal, the SMS message content is embedded into a text field of an ISUP message. The ISUP message is delivered to the destination terminal and the destination terminal recovers and displays the SMS message content received from the ISUP message.

In yet another embodiment, there is provided a method of delivering SMS message content via caller ID application. Upon receiving an SMS message from a source terminal directed to a destination terminal, a caller ID query is generated to receive caller ID information associated with the source terminal. Responsive to receiving the caller ID information, the caller ID information and the SMS message content is sent to a destination terminal via a caller ID application. The destination terminal recovers and displays the caller ID information and the SMS message content received from the caller ID application.

### BRIEF DESCRIPTION OF THE DRAWINGS

The foregoing and other advantages of the invention will become apparent upon reading the following detailed description and upon reference to the drawings.

FIG. 1 illustrates a exemplary communication network operable to deliver SMS messages to non-SMS devices according to embodiments of the invention;

FIG. 2 is a flowchart showing steps for delivering SMS messages to non-SMS devices according to embodiments of the invention;

FIG. 3 is a message sequence chart illustrating SMS message delivery via spoken text format according to an embodiment of the invention;

FIG. 4 is a message sequence chart illustrating SMS message delivery via spoken text format to a voicemail server according to an embodiment of the invention;

FIG. 5 is a message sequence chart illustrating SMS message delivery via ISUP-compatible text message according to an embodiment of the invention; and

FIG. 6 is a message sequence chart illustrating SMS message delivery via caller ID message according to an embodiment of the invention.

### DESCRIPTION OF THE PREFERRED EMBODIMENT(S)

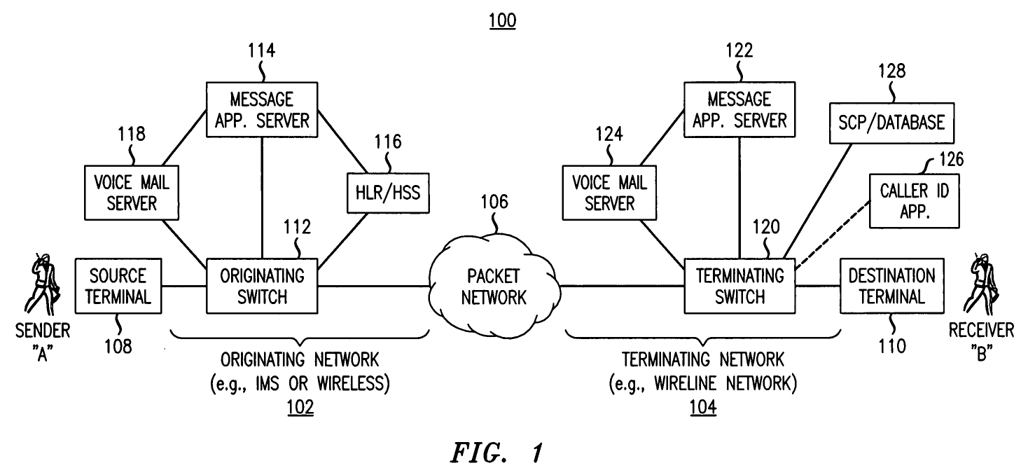

FIG. 1 illustrates a communication network 100 in an exemplary embodiment of the invention. Communication network 100 comprises an originating network 102 (comprising, for example, a wireless network or IMS network) operably connected to a terminating network 104 (comprising, for example, a wireline network) via a packet network 106. Communication network 100 is adapted to provide SMS messaging service between an SMS-capable source terminal 108 (associated with sender “A”) and a non-SMS destination terminal 110 (associated with receiver “B”).

The source terminal 108 may comprise any device having the capacity to send and receive SMS messages through communication network 100 including, without limitation, a wireless phone, wireline phone, a PDA, a PC, a VoIP phone or a SIP phone. The destination terminal 110 may comprise, for example and without limitation, a wireline POTS or ISDN phone that does not support conventional SMS service because for example, it does not have text display capability or it has a text display (not shown) adapted for services/features other than SMS. For convenience, the destination terminal is therefore termed a non-SMS device because it does not support conventional SMS text messaging. However, as will be described in greater detail hereinafter, the present invention is directed to providing SMS service to the non-SMS terminal 110 in some form appropriate to the destination terminal 110.

The source and destination terminals 108, 110 are logically connected to switching elements 112, 120 (“switches”) that are operable to process and switch calls and messages, including SMS messages between the source and destination terminals. Conventionally (as shown), the switch 112 serving the source terminal 108 is referred to as the originating switch and the switch 120 serving the destination terminal 110 is referred to as the terminating switch. The switches 112, 120 are connected by the packet network 106 (e.g., an IP network).

The switches 112, 120 will generally vary depending on the network topology in which they each operate. For example, the switches 112, 120 may comprise: in a wireline network, a central office switch such as a 5ESS® switching system; in a wireless network, a Mobile Switching Center (MSC) such as an AUTOPLEX™ switching system; and in an IMS network, a Call Session Control Function (CSCF) such as may reside in a Softswitch or Media Gateway. In the exemplary embodiment of FIG. 1, presuming the originating network 102 is a wireless network or IMS network and the terminating network is a wireline network, the originating switch 112 comprises an MSC or CSCF and the terminating switch 120 comprises a central office switch. As will be appreciated, the switches 112, 120 may be configured for operation with generally any suitable circuit, cell, or packet switching and routing technologies, including but not limited to Internet Protocol (IP) and Asynchronous Transfer Mode (ATM) technologies.

The communication network 100 is further illustrated as including, on the originating side, a message application server 114, a Home Location Register (HLR)/Home Subscriber Server (HSS) 116 and a voicemail server 118; and on the terminating side, a message application server 122, a voicemail server 124, a caller ID application 126 and a Service Control Point (SCP)/database 128. As will be appreciated, each of these devices are functional elements that may reside individually or collectively in one or more physical structures or may be implemented in software. Further, the devices may take different forms depending on the network topology of the originating and/or terminating network.

The message application servers 114, 122 comprise Short Message Service Centers (SMSCs) adapted to receive and process SMS messages between source and destination terminals. The HLR/HSS 116 is a location register that stores subscriber data and location information associated with source and destination terminals 102, 104. Conventionally, the term HLR refers to a location register of a wireless network and the term HSS refers to a location register of an IMS network.

During message processing, the originating message application server 114 communicates with the HLR/HSS to obtain address information associated with the source and destination terminals 102, 104, including address information of the terminating switch 120 serving destination terminal 104. SMS messages directed to the destination terminal 104 are sent to the terminating switch 120; and in turn, the terminating switch 120 forwards the SMS message to the terminating message application server 122 for continued processing.

The voicemail servers 118, 124 provide voicemail service for the originating and terminating networks, respectively. As is well known, voicemail service provides the capability for a source terminal to record and store a voice message for a destination device, for example, responsive to an attempted call to the destination device receiving a busy signal or no answer. As presently known, voicemail service does not support SMS message service. However, as will be described in greater detail, embodiments of the present invention provide the capability to deliver SMS messages via voicemail where appropriate.

As shown, the terminating network also includes a caller ID application 126 and SCP/database 128 for providing caller ID service to the destination terminal 110. The caller ID application 126 typically resides within the terminating switch 120. However, the caller ID application 126 is a functional element that may reside remotely from the terminating switch. As is well known, caller ID service is operable to send an identifier associated with the source terminal (e.g., name or directory number) to a text display associated with the destination terminal, presuming the destination terminal subscribes to the caller ID service and includes a caller ID display. It is noted, however, to the extent a caller ID display may be characterized as a text message, it is not an SMS message. As presently known, caller ID service does not provide SMS message service. However, as will be described in greater detail hereinafter, embodiments of the presention provide the capability to deliver SMS messages via caller ID display where appropriate.

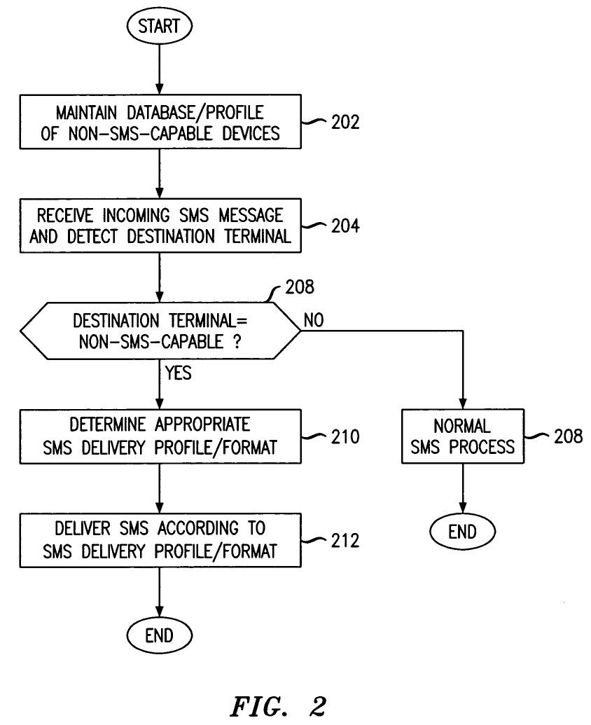

FIG. 2 is a flow chart showing a method for delivering SMS messages to non-SMS devices according to embodiments of the invention. The steps shown in FIG. 2 are implemented by either, or both of the message application servers 114, 122. For convenience, the steps of FIG. 2 will be described with reference to an “acting” message application server but this term will be understood to comprise either, or both SMSCs 114, 122 unless specified otherwise. Further, the steps of FIG. 2 will be described with reference to the elements of communication network 100 in FIG. 1, but the method is not limited to the network or elements of FIG. 1.

The method presumes at step 202, that an acting message application server maintains or accesses a database/profile of non-SMS devices or otherwise are operably connected to such a database. The database/profile is a functional element that may reside in the acting message application server or may reside in one or more physical devices remote from the acting message application server. In one embodiment, the database comprises a record of directory numbers of various non-SMS devices, such as wireline POTS or ISDN phones that do not support conventional SMS service. Advantageously, the record will further include an SMS delivery profile associated with the respective devices, i.e., to indicate an appropriate or preferred format for delivering SMS messages to the non-SMS devices. Optionally, the database may include a record and delivery profile associated with of SMS-capable devices as well as non-SMS devices.

According to embodiments of the present invention, the SMS delivery profile may comprise a spoken text message format, an ISUP-compatible text format or a caller ID message format, as appropriate to the particular non-SMS device. For example, it is contemplated that a spoken text format may be indicated for wireline phones not having a display; an ISUP-compatible text format may be indicated for ISDN phones with display; and caller ID message format may be indicated for phones having a caller ID display capability.

At step 204, an acting message application server receives an incoming SMS message and detects the directory number of destination terminal. For example, the acting message application server may determine the directory number of the destination terminal by inspecting a message header of the incoming SMS message. Next, at step 206, the acting message application server consults the database/profile to detect whether or not the directory number corresponds to a non-SMS device.

If the directory number is determined not to correspond to a non-SMS device (or alternatively, the directory number is affirmatively determined to correspond to an SMS-capable device), the incoming SMS message is processed normally at step 208.

If the directory number is determined to correspond to a non-SMS device, the acting message application server at step 210 consults the database/profile to detect the SMS delivery profile associated with the respective devices, i.e., to indicate an appropriate or preferred format for delivering SMS messages to the non-SMS devices. Optionally, if no delivery profile is indicated, the message application server may derive an SMS delivery profile or use a default SMS delivery profile based on characteristics of the destination device.

Finally, at step 212, the acting message application server delivers the SMS message according to the detected, derived or default delivery profile. As noted previously, the delivery profile may comprise a spoken text message format, an ISUP-compatible text format or a caller ID message format, as appropriate to the particular non-SMS destination device.

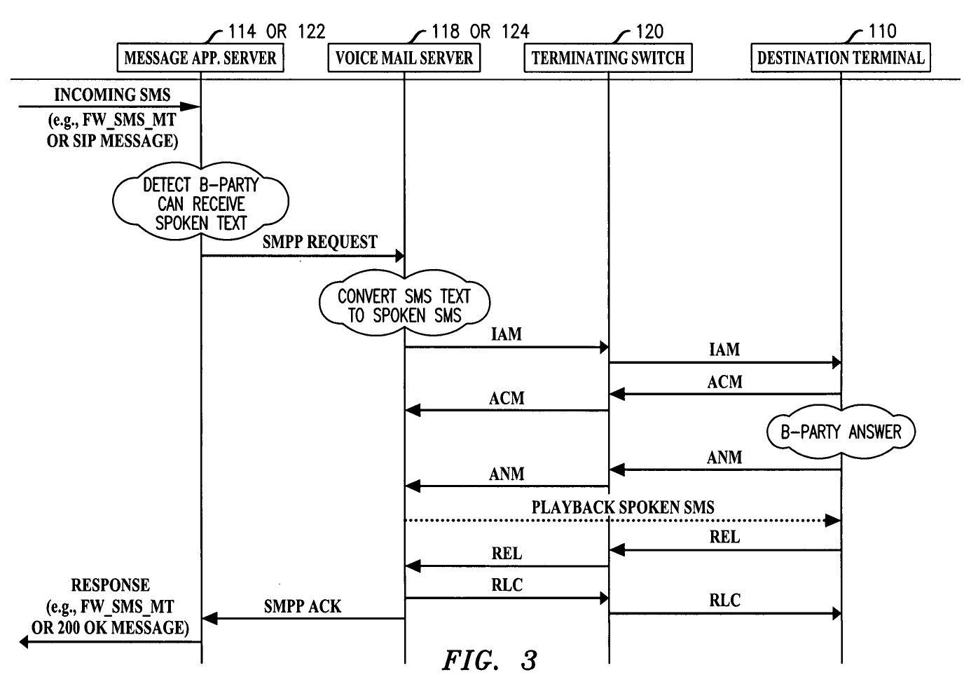

FIG. 3 through FIG. 6 show example message sequence charts corresponding to various delivery profiles. With reference to FIG. 1, the exemplary message sequences originate from a source terminal 108 of an originating network 102 (e.g., an IMS or wireless network) and are directed to a non-SMS destination terminal 110 of a terminating network 104 (e.g., a wireline network).

Referring initially to FIG. 3, there is shown a message sequence that demonstrates SMS message delivery via spoken-text format to non-SMS destination terminal 110. An incoming SMS message (FW_SMS_MT, in a wireless network; or a SIP message, in an IMS network) is received by an acting message application server. The acting message application server may comprise either SMSC 114 in the originating network 102 or SMSC 122 of the terminating network. The incoming SMS message includes a message header (not shown) that identifies terminal 108 as the source of the message and terminal 110 as the intended recipient of the message. In one embodiment, terminal 108 and 110 are identified by directory number.

The acting SMSC consults a database/profile such as described in relation to FIG. 2 to determine, based on the directory number of the destination terminal 110, that destination terminal 110 is a non-SMS device and that spoken text format is the appropriate or preferred format for delivering SMS messages to terminal 110. Having determined that spoken text is the appropriate or preferred format, the acting SMSC routes the SMS message to voicemail server 118 (if SMSC 114 is the acting SMSC) or voicemail server 124 (if SMSC 122 is the acting SMSC) via SMPP interface; and the voicemail server converts the SMS text message to spoken text format.

The voicemail server thereafter initiates a wireline-format outcall sequence (as shown, an ISUP (ISDN signaling user part) sequence) to communicate with the terminating switch 120 and destination terminal 110. The ISUP sequence comprises an IAM (initial address message) sent from the voicemail server to the destination terminal via the terminating switch; and an ACM (address complete message) returned from the destination terminal to the voicemail server via the terminating switch which effects a ring sequence on the destination terminal 110.

When the receiving party “B” answers the call (i.e., the outcall is successful), the destination terminal 110 returns an ANM (ANswer message) via the terminating switch. The ANM indicates to the terminating switch whether the call was answered or not answered. In the present example, the ANM indicates that the call is answered; and responsive to the ANM, the voicemail server begins to playback the spoken-text SMS message to the destinaton terminal. When the playback is completed and the party “B” hangs up the phone, the destination terminal sends a REL (RELease message) to the voicemail server via the terminating switch; and the voicemail server responds with a RLC (ReLease Complete message). The voicemail server replies to the acting message application server with a SMPP Ack and in turn, the message application server sends a Response message (FW_SMS_MT, in a wireless network; or 200 OK message, in an IMS network) to the originating terminal 108.

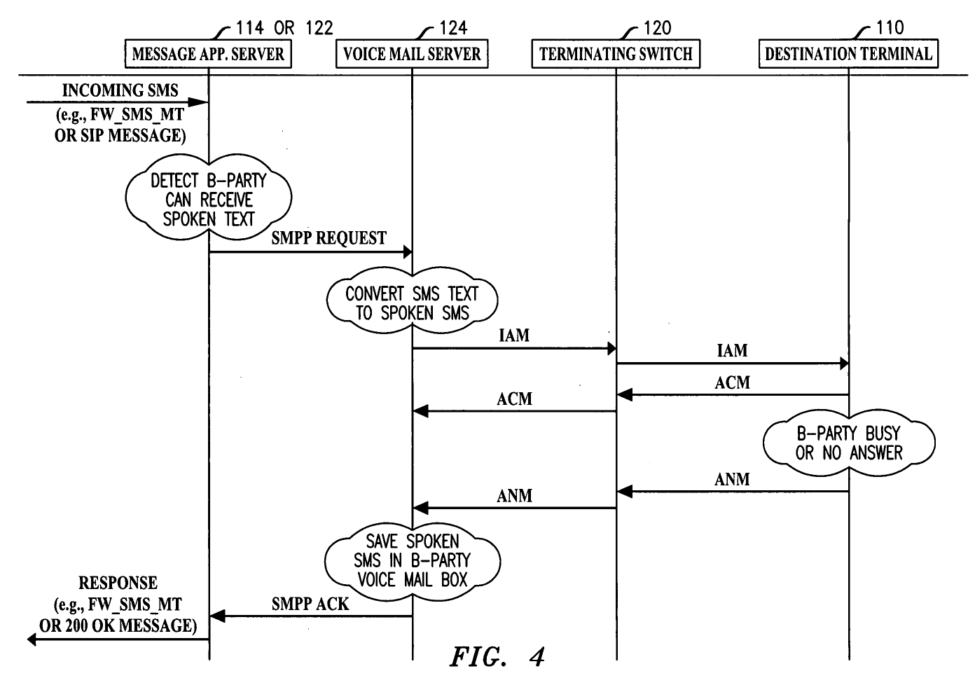

FIG. 4 shows a message sequence associated with SMS message delivery via spoken-text format to a voicemail server associated with a non-SMS destination terminal 110. The message sequence of FIG. 4 begins in similar manner as the message sequence described in relation to FIG. 3, by an acting message application server receiving an incoming SMS message (FW_SMS_MT, in a wireless network; or a SIP message, in an IMS network) and consulting a database/profile to determine that destination terminal 10 is a non-SMS device and that spoken text format is the appropriate or preferred format for delivering SMS messages to terminal 110.

Having determined that spoken text is the appropriate or preferred format, the acting SMSC routes the SMS message to voicemail server 124 via SMPP interface; and the voicemail server converts the SMS text message to spoken text format. The voicemail server 124 thereafter initiates a wireline-format message sequence (as shown, an ISUP (ISDN signaling user part) sequence) to communicate with the terminating switch 120 and destination terminal 110.

In the present example, the call is not answered and the destination terminal 110 returns an ANM (ANswer message) to the terminating switch indicating that the call is not answered. Responsive to the ANM, the voicemail server 124 effects no answer treatment by saving the spoken-text SMS message in a voicemail box associated with the destination terminal. The destination terminal may later retrieve and playback the spoken-text SMS message, as is well known, by connecting to the voicemail server 124. After saving the spoken-text SMS message, the voicemail server 124 replies to the acting message application server with a SMPP Ack and in turn, the message application server sends a Response message (FW_SMS_MT, in a wireless network; or 200 OK message, in an IMS network) to the originating terminal 108.

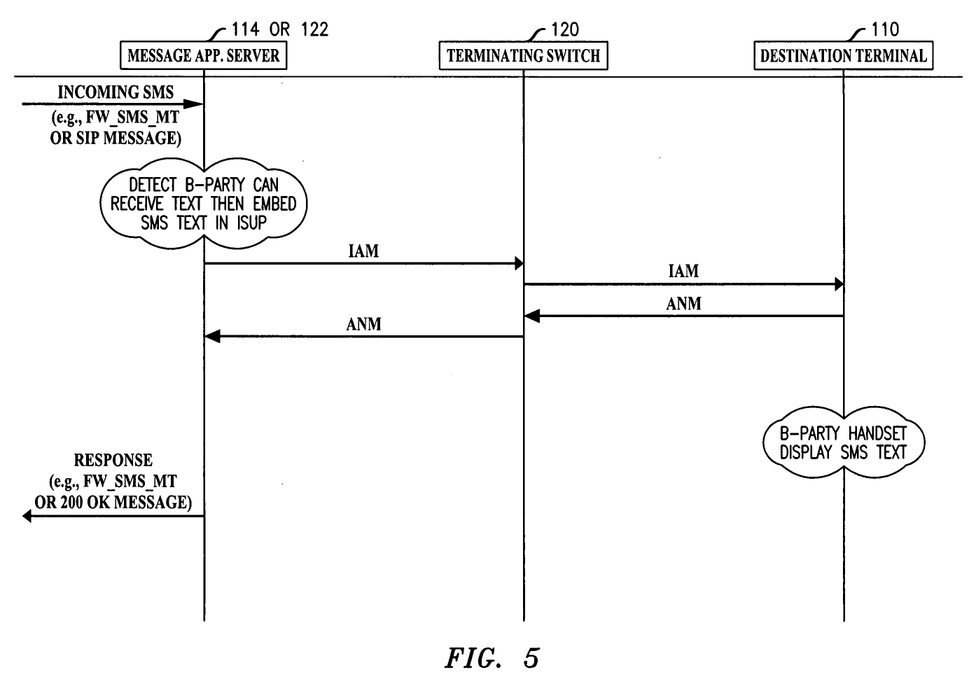

FIG. 5 shows a message sequence associated with SMS message delivery via ISUP-compatible text display to non-SMS terminal 110. The message sequence begins by an acting message application server (e.g., SMSC 114 or 122) receiving an incoming SMS message (FW_SMS_MT, in a wireless network; or a SIP message, in an IMS network) and consulting a database/profile to determine that destination terminal 110 is a non-SMS device and that text delivery via ISUP format is the appropriate or preferred format for delivering SMS messages to terminal 110.

Having determined that non-SMS text display (e.g., ISDN display) is the appropriate or preferred format, the acting SMSC embeds the content of the SMS message into a text field of an ISUP-format message and initiates a wireline outcall sequence (as shown, an ISUP sequence) to send the ISUP-format message to the destination terminal 110. The ISUP sequence comprises an LAM (initial address message) sent from the message application server to the destination terminal via the terminating switch; and an ACM (address complete message) returned from the destination terminal to the message application server via the terminating switch.

The destination terminal retrieves the SMS contents from the text field of the ISUP-format message and displays the text message via its own display (e.g., ISDN display). Having sent the ISUP-compatible text message to the destination terminal, the message application server sends a Response message (FW_SMS_MT, in a wireless network; or 200 OK message, in an IMS network) to the originating terminal 108.

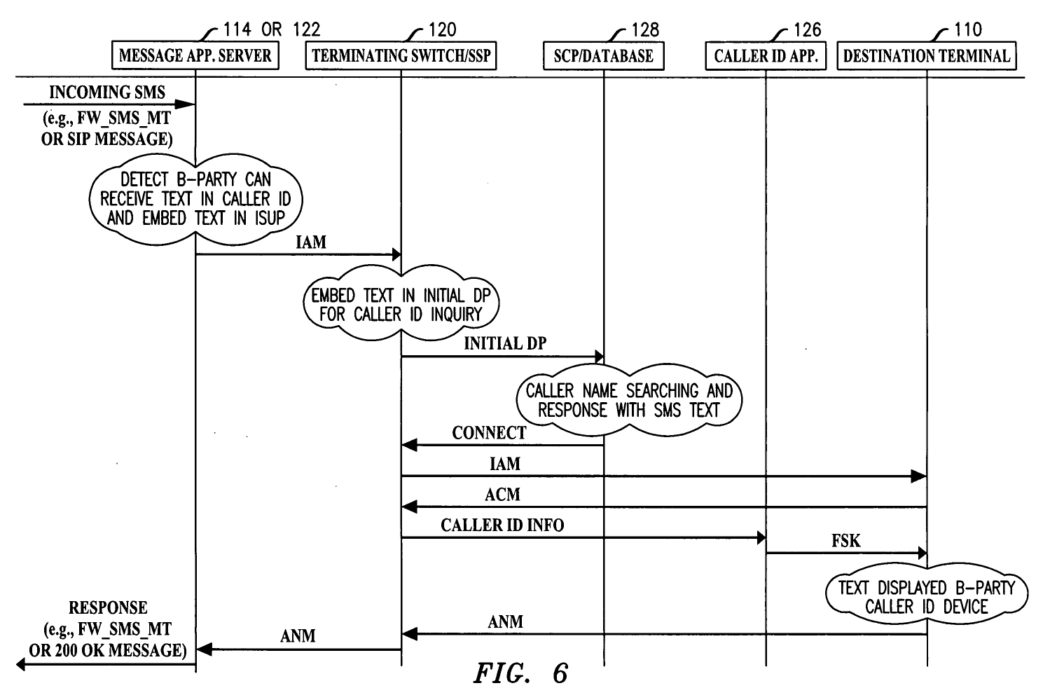

FIG. 6 shows a message sequence associated with SMS message delivery via caller-ID text message to non-SMS terminal 110. An acting message application server (e.g., SMSC 114 or 122) receiving an incoming SMS message (FW_SMS_MT, in a wireless network; or a SIP message, in an IMS network) and consults a database/profile to determine that destination terminal 110 is a non-SMS device and that text delivery via caller-ID-compatible text message is the appropriate or preferred format for delivering SMS messages to terminal 110. Having determined that a caller-ID-compatible text message is the appropriate or preferred format, the acting SMSC embeds the content of the SMS message into a text field of an ISUP-format message (as shown, an ISUP IAM message) and initiates a wireline-format outcall sequence by sending the IAM message to the terminating switch 120.

In one embodiment, the terminating switch 120 includes an Advanced Intelligent Network (AIN) component known as a service switching point (SSP). As well known to those skilled in the art, the SSP recognizes and responds to triggers and communicates (typically via SS7 signaling protocol) with other AIN components to perform call processing functions associated with caller ID and other services. When the IAM message is received by the terminating switch/SSP, a trigger is activated that causes the SSP to generate and send a caller ID query (as shown, an Initial DP message) to SCP 128. The terminating switch/SSP detects the SMS message contents from the LAM text field and embeds the SMS message contents into a text field of the Initial DP message before passing to the SCP. The Initial DP Message is an INAP (Intelligent Network Application Protocol) Operation commonly used to implement caller ID service.

It is noted, the term SMS message contents, as used hereinafter, refers generally to the information conveyed by the original SMS message without limitation as to format. The term “embeds” refers generally to including the SMS message content in a separate message (e.g., IAM or INAP message). The SMS message content may be embedded by means of virtually any symbols, characters, codes or the like appropriate to the separate message.

The SCP 128 is an AIN component that stores or access a database to locate and retrieve caller ID information and other call control information in response to the query from the SSP. For convenience, the SCP is identified as an SCP/datase. As will be appreciated, the SCP/database is a functional element that may reside in one or more physical structures. Responsive to receiving the caller ID query (e.g., Initial DP message), the SCP 128 retrieves caller ID information associated with the calling party and returns caller ID information to the SSP (as shown, via Connect message). According to principles of the present invention, the SCP further detects the SMS message contents from the caller ID query and returns the message contents to the SSP via a text field of the Connect message. In such manner, the SSP receives caller ID information and SMS message contents from the SCP (and hence, the SSP need not have stored the SMS message contents previously received from the SMSC). Alternatively, the SSP may store the SMS message contents previously received from the SMSC (and in such case, the SSP need not send or receive SMS message contents from the SCP).

Responsive to receiving the Connect message, the terminating switch continues the wireline outcall sequence by sending an IAM (initial address message) to the destination terminal; and the destination terminal returns an ACM (address complete message) which effects a ring sequence on the destination terminal 110. Sometime prior to or during the ring sequence, the terminating switch/SSP sends the caller ID information and SMS message contents to caller ID application 126. In one embodiment, the caller ID application sends the caller ID information and SMS message contents to the destination terminal by frequency-shift keying (FSK) signaling between the first and second ring tone. The caller ID device associated with the destination terminal captures, displays and stores in memory the caller ID information and SMS message contents. The destination terminal 110 returns an ANM (ANswer message) via the terminating switch and the terminating switch sends a Response message (FW_SMS_MT, in a wireless network; or 200 OK message, in an IMS network) to the originating terminal 108.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The invention may be deployed in generally any wireline, wireless or IMS network including those with network topologies that differ from FIG. 1 or that use message sequences other than shown in FIG. 3 through FIG. 6. The scope of the invention is, therefore, indicated by the appended claims rather than by the foregoing description. All changes that come within the meaning and range of equivalency of the claims are to be embraced within their scope.

What is claimed is:

1. A method comprising:
receiving an SMS message directed to a destination terminal;
determining whether the destination terminal is a non-SMS device;
if the destination terminal is a non-SMS device,
determining a delivery profile appropriate to the non-SMS device; and
delivering the SMS message to the non-SMS device according to the delivery profile.

2. The method of claim 1, performed by an SMS message application server associated with an originating network of the SMS message.

3. The method of claim 1, performed by an SMS message application server associated with a terminating network of the SMS message.

4. The method of claim 1, wherein the step of determining whether the destination terminal is a non-SMS device comprises:
identifying a directory number of the destination terminal; and
consulting a database including indicia of one or more directory numbers corresponding to non-SMS devices to determine whether the directory number corresponds to a non-SMS device.

5. The method of claim 4 wherein, if the directory number corresponds to a non-SMS device, the step of determining a delivery profile comprises consulting a database to determine the delivery profile associated with the non-SMS device.

6. The method of claim 5, further comprising maintaining the database including indicia of one or more directory numbers corresponding to non-SMS devices and indicia of delivery profiles associated with the non-SMS devices.

7. The method of claim 1, wherein the delivery profile appropriate to the non-SMS device comprises a spoken text format.

8. The method of claim 7, further comprising:
attempting a call to the destination terminal;
if the destination terminal answers the call, delivering the SMS message via spoken text format to the destination terminal.

9. The method of claim 7, further comprising:
attempting a call to the destination terminal;
if the destination terminal does not answer the call, delivering the SMS message via spoken text format to a voicemail server associated with the destination terminal.

10. The method of claim 1, wherein the delivery profile appropriate to the non-SMS device comprises an ISUP-compatible message format.

11. The method of claim 1, wherein the delivery profile appropriate to the non-SMS device comprises a caller ID message format.

12. A method of delivering SMS message content via spoken text format, the method comprising:
receiving an incoming SMS message directed to a destination terminal, the SMS message including SMS message content;
converting the SMS message content to spoken text, yielding a spoken-text SMS message;
attempting a call to the destination terminal; and
if the destination terminal answers the call, delivering the spoken-text SMS message to the destination terminal.

13. The method of claim 12, further comprising:
if the destination terminal does not answer the call, delivering the spoken-text SMS message to a voicemail server associated with the destination terminal, the spoken-text message thereafter being retrievable by the destination terminal calling the voicemail server.

14. A method of delivering SMS message content via ISUP message, the method comprising:
receiving an incoming SMS message directed to a destination terminal, the SMS message including SMS message content;
embedding the SMS message content into a text field of an ISUP message;
delivering the ISUP message to a destination terminal, the destination terminal recovering and displaying the SMS message content received from the ISUP message.

15. A method of delivering SMS message content via caller ID application, the method comprising:
receiving an incoming SMS message from a source terminal directed to a destination terminal, the SMS message including SMS message content;
generating and sending a caller ID query to receive caller ID information associated with the source terminal;
responsive to receiving the caller ID information, sending the caller ID information and the SMS message content to a destination terminal via a caller ID application, the destination terminal recovering and displaying the caller ID information and the SMS message content received from the caller ID application.
